(19) United States
(12) Patent Application Publication
(10) Pub. No.: US 2025/0123821 A1
(43) Pub. Date: Apr. 17, 2025

(54) INTELLIGENT WEBPAGE SCREEN CAPTURE

(71) Applicant: Consensus Sales, LLC, Atlanta, GA (US)

(72) Inventors: Brian Zurcher, St. George, UT (US); David Lindes, Salt Lake City, UT (US); Garin Hess, Saratoga Springs, UT (US); Jeannie Laochaloenvanich, Pflugerville, TX (US); Derek Gilbert, Draper, UT (US); Justin Ware, Raleigh, NC (US)

(21) Appl. No.: 18/916,565

(22) Filed: Oct. 15, 2024

Related U.S. Application Data
(60) Provisional application No. 63/589,946, filed on Oct. 12, 2023.

(51) Int. Cl. G06F 8/38; G06F 3/04842; G06F 8/34

(52) U.S. Cl. CPC G06F 8/38; G06F 3/04842; G06F 8/34

(57) ABSTRACT

A system may identify editable elements on a graphical page displayed on a client device and display graphical indications showing the editable elements on the graphical page. In some instances, the system may receive a first user input selecting an element of the indicated editable elements. The system may receive a second user input modifying the first element and may modify code of the graphical page based on the second user input to change the appearance of the graphical page. In some instances, the system may receive a third user input requesting an image capture of the changed appearance of the graphical page. For example, the system may automatically remove the graphical indications and capture the graphical page with its changed appearance.

### BACKGROUND

This application relates to the creation of online demonstrations. For example, technologies described in this application may allow administrative users to intelligently capture images for use in a digital demonstration presentation.

A digital demonstration of a computer program or website may include a limited set of the code of the website or computer application, such as its operation in a sandbox, which may access, use, or copy code from the website or application. Unfortunately, creating a demo based on an application or website is often a very cumbersome process that is easily broken as the code may change or may include bugs, especially if it accesses external resources of a webpage. Additionally, these active environments, such as where the code is copied or used in a sandbox, are complicated, may include numerous distractions (e.g., elements that are not being demonstrated), and tend to be very large files. Accordingly, these types of demos create numerous technological issues, such as crashes, latency, bandwidth consumption, or increased programming time.

Accordingly, merely copying the code of a webpage and using it in a demo may require significant rework before the look and feel of the original webpage are restored. Where sanitization or manipulation of the data on the webpage is required, the code of the website may need to be repaired in addition to the sanitization or manipulation. Accordingly, significant re-work of the code is often required before fake or sanitized data can be displayed via these methods, for example, where personal, inaccurate, or irrelevant data is shown on the webpage that is not desired in a demonstration.

In some previous technologies, screen captures of a website were used to create a static set of images. Unfortunately, these technologies do not allow sanitization or manipulation of the screen capture. At best, these technologies used post-processing techniques to change images, such as photo editing software to redact information once the images have been captured, but this is cumbersome, slow, must be performed separately on each image, and consumes both time and computing resources. For example, previous technologies overlayed opaque boxes on an image to allow its data to be modified or redacted.

### SUMMARY

A system for intelligent webpage screen capture can be configured to perform particular operations or actions by virtue of having software, firmware, hardware, or a combination of them installed on the system that in operation causes or cause the system to perform the actions. In some aspects, the techniques described herein relate to a computer-implemented method including: identifying, by one or more processors, one or more editable elements on a graphical page displayed on a client device; displaying, by the one or more processors, one or more graphical indications at the one or more editable elements on the graphical page; receiving, by the one or more processors, a first user input selecting a first element of the one or more editable elements; receiving, by the one or more processors, a second user input modifying the first element; modifying, by the one or more processors, code of the graphical page based on the second user input to change an appearance of the graphical page; and receiving, by the one or more processors, a third user input requesting an image capture of the changed appearance of the graphical page.

In some aspects, the techniques described herein relate to a computer-implemented method, further including: receiving, by the one or more processors, a fourth user input requesting to edit the appearance of the graphical page displayed on the client device, the fourth user input preceding the first user input.

In some aspects, the techniques described herein relate to a computer-implemented method, wherein: the graphical page includes a webpage displayed in a web browser; and the code of the graphical page includes HTML.

In some aspects, the techniques described herein relate to a computer-implemented method, further including: responsive to receiving the third user input, removing, by the one or more processors, the one or more graphical indications of the one or more editable elements; performing, by the one or more processors, a screen capture of the graphical page to generate an image file; and storing, by the one or more processors, the generated image file in a database accessible to the one or more processors.

In some aspects, the techniques described herein relate to a computer-implemented method, further including: determining, by the one or more processors, one or more edges for the screen capture; and performing, by the one or more processors, the screen capture using the one or more edges.

In some aspects, the techniques described herein relate to a computer-implemented method, wherein: wherein determining the one or more edges includes receiving a defined resolution for the screen capture.

In some aspects, the techniques described herein relate to a computer-implemented method, wherein: displaying the one or more graphical indications includes highlighting a plurality of content regions surrounding the one or more editable elements on the graphical page.

In some aspects, the techniques described herein relate to a computer-implemented method, wherein: displaying the one or more graphical indications includes highlighting the one or more editable elements on the graphical page when hovered over by a cursor on the graphical page.

In some aspects, the techniques described herein relate to a computer-implemented method, wherein: the first element includes text displayed on the graphical page; receiving the second user input modifying the first element includes receiving text input at a location at which the first element is displayed on the graphical page; and modifying the code of the graphical page based on the second user input includes replacing text corresponding to the text displayed on the graphical page with the received text in the code.

In some aspects, the techniques described herein relate to a computer-implemented method, further including: receiving, by the one or more processors, a fourth user input defining an HTML element; and overlaying, the HTML element over the captured image.

In some aspects, the techniques described herein relate to a system including: one or more processors; and a memory storing instructions that, when executed by the one or more processors causes the system to perform operations including: identifying one or more editable elements on a graphical page displayed on a client device; displaying one or more graphical indications at the one or more editable elements on the graphical page; receiving a first user input selecting a first element of the one or more editable elements; receiving a second user input modifying the first element; modifying code of the graphical page based on the second user input to change an appearance of the graphical page; and receiving a third user input requesting an image capture of the changed appearance of the graphical page.

In some aspects, the techniques described herein relate to a system, wherein the operations further include: receiving a fourth user input requesting to edit the appearance of the graphical page displayed on the client device, the fourth user input preceding the first user input.

In some aspects, the techniques described herein relate to a system, wherein: the graphical page includes a webpage displayed in a web browser; and the code of the graphical page includes HTML.

In some aspects, the techniques described herein relate to a system, wherein the operations further include: responsive to receiving the third user input, removing the one or more graphical indications of the one or more editable elements; performing a screen capture of the graphical page to generate an image file; and storing the generated image file in a database accessible to the one or more processors.

In some aspects, the techniques described herein relate to a system, wherein the operations further include: determining one or more edges for the screen capture; and performing the screen capture using the one or more edges.

In some aspects, the techniques described herein relate to a system, wherein: wherein determining the one or more edges includes receiving a defined resolution for the screen capture.

In some aspects, the techniques described herein relate to a system, wherein: displaying the one or more graphical indications includes highlighting a plurality of content regions surrounding the one or more editable elements on the graphical page.

In some aspects, the techniques described herein relate to a system, wherein: displaying the one or more graphical indications includes highlighting the one or more editable elements on the graphical page when hovered over by a cursor on the graphical page.

In some aspects, the techniques described herein relate to a system, wherein: the first element includes text displayed on the graphical page; receiving the second user input modifying the first element includes receiving text input at a location at which the first element is displayed on the graphical page; and modifying the code of the graphical page based on the second user input includes replacing text corresponding to the text displayed on the graphical page with the received text in the code.

In some aspects, the techniques described herein relate to a system, wherein the operations further include: receiving a fourth user input defining an HTML element; and overlaying, the HTML element over the captured image.

Other implementations of one or more of these aspects include corresponding systems, apparatus, and computer programs, configured to perform the actions of the methods, encoded on computer storage devices.

It should be understood that the language used in the present disclosure has been principally selected for readability and instructional purposes, and not to limit the scope of the subject matter disclosed herein.

### BRIEF DESCRIPTION OF THE DRAWINGS

The disclosure is illustrated by way of example, and not by way of limitation in the figures of the accompanying drawings in which like reference numerals are used to refer to similar elements.

FIG. 1 is a block diagram of an example system for providing intelligent webpage screen capture and demo generation.

FIG. 2 is a block diagram of an example computing system.

FIGS. 3A and 3B illustrate a flowchart of example method for providing intelligent webpage screen capture and demo generation.

FIGS. 4A-4F illustrate example graphical user interfaces for selecting and editing elements of pages.

FIG. 4G illustrates an example graphical user interface for determining a dimension or resolution of an image capture.

FIG. 4H illustrates an example graphical user interface in which an image of an edited page is captured.

FIG. 4I illustrates an example graphical user interface in which multiple previews of captured images are displayed.

FIG. 4J illustrates an example graphical user interface in which an image capture utility interfaces with a demo application.

FIG. 5A illustrates an example graphical user interface showing an example demonstration presentation using a captured image and added user interface elements.

FIGS. 5B-5E illustrate example graphical user interfaces for configuring user interface elements of a demo application, for example, with a captured image.

FIG. 5F illustrates an example graphical user interface in which a demo presentation is displayed to a user.

### DESCRIPTION

The present disclosure relates to systems and methods for an intelligent webpage screen capture, which may be used to capture images, for example, for a demonstration presentation (“demo” or “demonstration”) using the captured images of the webpage(s). In some instances, the technology may include overlaying user interface elements over the captured images in a demonstration presentation.

Implementations of the technology provide a system for building a customized demo by a stakeholder, such as an administrator, salesperson, educator, or other user. For example, the technology may include a system that captures an edited screen capture or image of a webpage. In some instances, editable and/or interactable graphical elements may be added to the captured screenshot in a demo, so that a user may interact with the intelligent screenshot as if it were the webpage but without necessarily using the actual code of the webpage.

For example, some implementations of the technology described herein provides an intelligent system for drawing attention to editable elements of a webpage, automatically selecting consistent portions of the webpage for a screen capture, editing the displayed webpage, removing the highlighting and capturing the sanitized/manipulated/edited version of the webpage, and, in some instances, automatically adding the pre-edited version to a demo application for building a demo.

In some implementations, the technology may analyze a front or back end of a webpage to determine editable elements (e.g., based on the DOM or other code), and graphically indicate those elements to a user. A user may select an element to be modified, and the technology may receive a user input and modify the webpage (e.g., by editing the underlying HTML) to modify its appearance accordingly. For example, a user may change text that includes confidential information to sanitize, redact, or otherwise change it. Images or other elements may also be edited using this technique. In some instances, such as where the technology displays highlighting or other graphical elements showing the edited and/or editable fields when a user selects a capture button, it may clear the highlighting or any overlays by the technology when capturing the image of the edited webpage. A resolution or automatic edge detection for a webpage or web browser tab may be used to automatically align the screen capture with the displayed area of the webpage. Once the edited image is captured, it may be transmitted directly to a demo application to build a demo, such as where one or more live user interface (“UI”) elements (e.g., a new HMTL box) are overlayed on the image.

Because the technology may edit code (e.g., an HTML—Hypertext Markup Language or DOM—Document Object Model, etc.) of the webpage as it is displayed (e.g., in a web browser), the appearance of the edited information, such as text fonts and sizes, locations, layouts, etc., remain consistent with that of the original webpage. For example, unlike where post-processing of an image may require significant effort to match the original style of the webpage, this system allows the edits to the screenshot to remain in the same style and be seamlessly integrated into the generated image. Where multiple screen captures of the same webpage are being generated, this system also allows each to have the same edited information without having to perform post-processing on each of the images.

Additionally, because the technology may edit data on an active webpage, the remainder of the webpage, such as those elements that access backend or external resources remain functional.

In some implementations, the technology (e.g., an intelligent screen capture utility) may generate a demonstration presentation that allows interaction with a website, for example, by copying the DOM (Document Object Model) or other HTML of the website to create a mirror or sandboxed copy of the website. This copy of the website may be used in a demo; although, as noted above, copying the code or model often results in errors or other issues. Similarly, each time an aspect of the webpage or application (e.g., code, a graphical element, a layout, a link, etc.) is changed in the original or in the copy, the demonstration presentation may cease to operate properly. Accordingly, in order to address the issues of the background while retaining some functionality, the technology described herein provides numerous operations, features, and advantages, for example, over an ordinary image or over copying code from a webpage or application.

The technology may include using one or more static images to create a demonstration, and, in some implementations, in order to allow users to interact with certain portions of the image as if with the active application or website, the technology may use interactable user interface elements, which may be overlayed over and linked to the image(s). For example, an HTML box may be placed over a screenshot to provide limited functionality of the product being demoed as a type of façade that does not use the real product but provides the look and feel of the product with limited functionality. Additionally, because the live UI element overlays may be defined by a creator/administrator, the images, overlays, and other elements of the demonstration presentation may be created with a defined flow and/or logic that requires and tracks user engagement. For instance, these elements may be organized into a story that provides an engaging demonstration without using all elements of the original website/application. Similarly, because the overlayed UI elements may be defined in the demo and decoupled from the original code of the webpage or application, if the original website/application changes, it would not break the functionality of the demo. It should be noted that although this description describes capturing and creating demonstrations of webpages and applications, other types of content are possible and contemplated herein.

Accordingly, in some implementations, the technology may allow a generated demo to illustrate interactions with certain functions of an application or website in a narrow, non-live way without granting users access to the application/website itself or creating and maintaining a sandbox environment. The demo versions of the application/website, using the technology, may be sanitized and, using these techniques, are much less likely to break during access by a user to the generated demonstration presentation.

With reference to the figures, reference numbers may be used to refer to example components found in any of the figures regardless of whether those reference numbers are shown in the figure being described. Further, where a reference number includes a letter referring to one of multiple similar components (e.g., component 000a, 000b, and 000n), the reference number may be used without the letter to refer to one or all of the similar components.

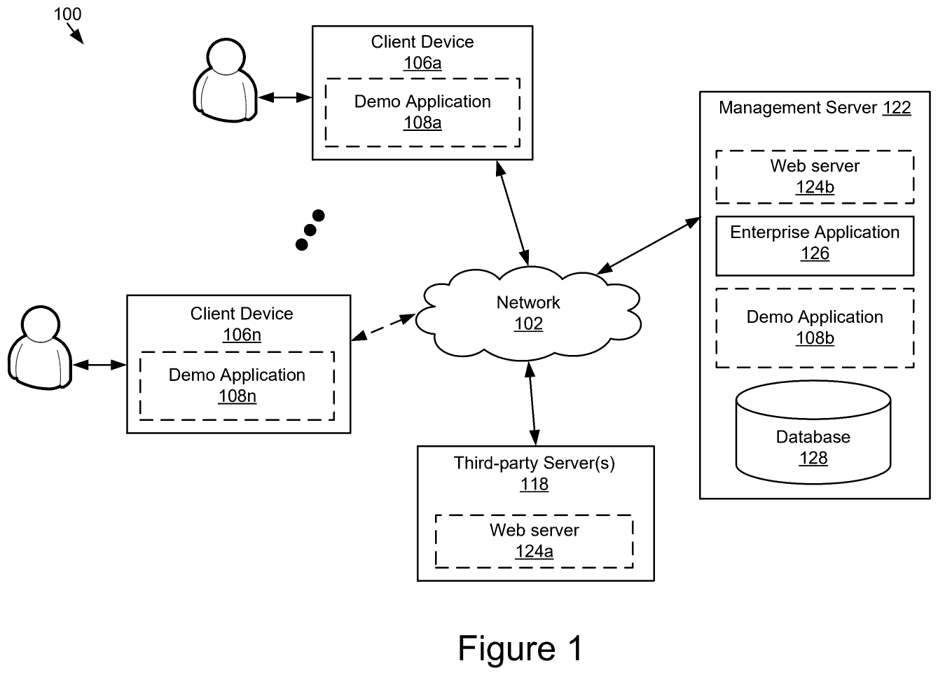

FIG. 1 is a block diagram of an example system 100 for providing intelligent webpage screen capture and demo generation. The demo may also include layered information previewed in customizable cards and multi-layered information in hot spots or other UI elements on a graphical interface. The illustrated system 100 may include one or more client devices 106, a third-party server 118, and/or a management server 122, which may run instances of the demo application 108a, 108b, and 108n and which may be electronically communicatively coupled via a network 102 for interaction with one another, although other system configurations are possible including other devices, systems, and networks. For example, the system 100 could include any number of client devices 106, third-party servers 118, management server(s) 122, and other systems and devices.

The network 102 may include any number of networks and/or network types. For example, the network 102 may include, but is not limited to, one or more local area networks (LANs), wide area networks (WANs) (e.g., the Internet), virtual private networks (VPNs), wireless wide area network (WWANs), WiMAX® networks, personal area networks (PANs) (e.g., Bluetooth® communication networks), various combinations thereof, etc. These private and/or public networks may have any number of configurations and/or topologies, and data may be transmitted via the networks using a variety of different communication protocols including, for example, various Internet layer, transport layer, or application layer protocols. For example, data may be transmitted via the networks using TCP/IP, UDP, TCP, HTTP, HTTPS, DASH, RTSP, RTP, RTCP, VOIP, FTP, WS, WAP, SMS, MMS, XMS, IMAP, SMTP, POP, WebDAV, or other known protocols.

The client device(s) 106 (e.g., multiple client devices 106 may be used by a single participant, multiple participants, stakeholders, administrators, or by other users) includes one or more computing devices having data processing and communication capabilities. The client device 106 may couple to and communicate with other client devices 106 and the other entities of the system 100 via the network 102 using a wireless and/or wired connection, such as the management server 122. Examples of client devices 106 may include, but are not limited to, mobile phones, wearables, tablets, laptops, desktops, netbooks, server appliances, servers, virtual machines, televisions, XR (extended reality) headsets, etc. The system 100 may include any number of client devices 106, including client devices 106 of the same or different type.

In some implementations, one or multiple client devices 106 may be used with a demo application 108 to execute an instance or component thereof or to otherwise access the demo application 108, for example, via the web server 124.

The management server 122 and its components may aggregate information about and provide data associated with the systems and processes described herein to a multiplicity of users on a multiplicity of client devices 106, for example, as described in reference to various users and client devices 106 described herein. In some implementations, a single user may use more than one client device 106a . . . 106n, which the management server 122 as described above, or multiple users may use multiple client devices 106a . . . 106n to interact with to perform operations described herein. In some implementations, the management server 122 may communicate with and provide information to a client device 106.

The management server 122 may include a web server 124b, an enterprise application 126, a demo application 108, and/or a database 128. In some configurations, the enterprise application 126 and/or demo application 108 may be distributed over the network 102 on disparate devices in disparate locations or may reside at the same location. The client device 106a and/or the management server 122 may each include an instance of the demo application 108 and/or portions/functionalities thereof. The client devices 106 may also store and/or operate other software such as a demo application 108, an operating system, other applications, etc., that are configured to interact with the management server 122 via the network 102.

The management server 122 and/or the third-party server 118 have data processing, storing, and communication capabilities, as discussed elsewhere herein. For example, the servers 118 and/or 122 may include one or more hardware servers, server arrays, storage devices and/or systems, etc. In some implementations, the servers 118 and/or 122 may include one or more virtual servers, which operate in a host server environment.

In some implementations, the enterprise application 126 may receive communications from a client device 106 in order to perform the functionality described herein. The enterprise application 126 may receive information and provide information to the demo application 108 to generate adaptable graphical interfaces described, as well as perform and provide analytics and other operations. In some implementations, the enterprise application 126 may perform additional operations and communications based on the information received from client devices 106, as described elsewhere herein.

The database 128 may be stored on one or more information sources for storing and providing access to data, such as the data storage device 208. The database 128 may store data describing client devices 106, instances of the demo application 108, media segments, HTML, images, UI elements, composite data files, metadata, preferences, configurations, and other information, such as described herein.

A third-party server 118 can host services such as a third-party application (not shown) or various webpages, which may be individual and/or incorporated into the services provided by the management server 122. For example, the third-party server 118 may represent one or more item databases, forums, company websites, etc. For instance, a third-party server 118 may provide automatically delivered and processed data, such as frames, attributes, media segments, and/or services, such as media processing services or other services. In some implementations, the third-party server 118 may provide the content that is being demoed, such as an application or website. In some cases, it may include a web server 124a for serving the content to client device 106 or management server 112, which may, for example, host the demo application 108 (and/or the intelligent screen capture utility 232), which may capture images of the content, as noted elsewhere herein.

The demo application 108a . . . 108n and web server 124a . . . 124b, for instance, are described in further detail below. Additionally, while the intelligent screen capture (ISC) utility 232 is described and illustrated below as being a component of the demo application 108, it should be noted that it may be a separate application and/or may interface with the demo application 108. For example, the ISC utility 232 may be executed on a client device 106, such as on a browser plugin, and it may transmit data or otherwise interface (e.g., via an API) with the demo application 108 (e.g., operating on a management server 122 or otherwise).

It should be understood that the system 100 illustrated in FIG. 1 is representative of an example system and that a variety of different system environments and configurations are contemplated and are within the scope of the present disclosure. For instance, various acts and/or functionality may be moved from a server to a client, or vice versa, data may be consolidated into a single data store or further segmented into additional data stores, and some implementations may include additional or fewer computing devices, services, and/or networks, and may implement various functionality client or server-side. Further, various entities of the system may be integrated into a single computing device or system or divided into additional computing devices or systems, etc.

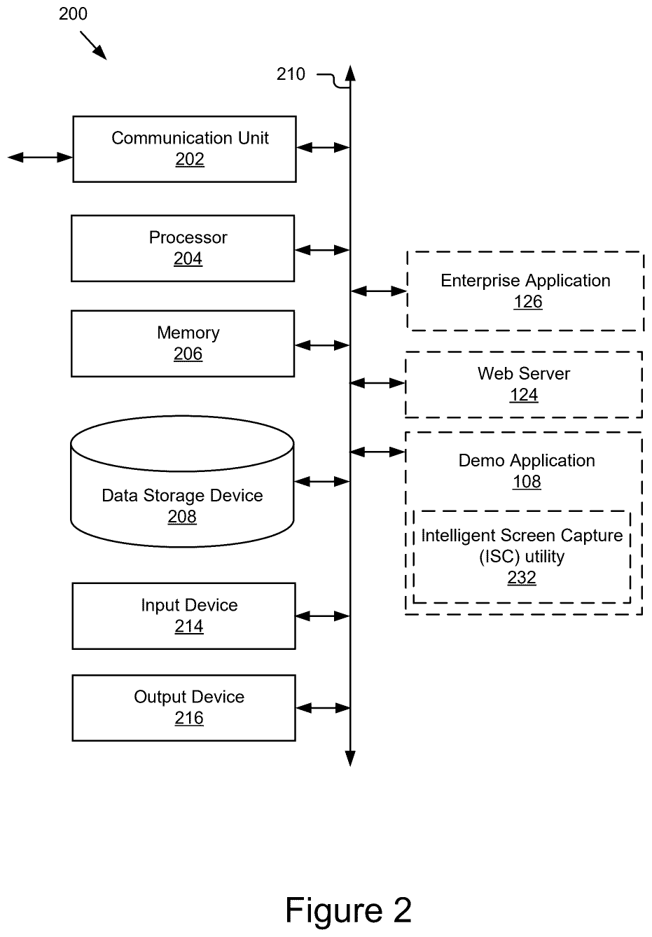

FIG. 2 is a block diagram of an example computing system 200, which may represent computer architecture of a client device 106, third-party server 118, management server 122, and/or another device described herein, depending on the implementation. In some implementations, as depicted in FIG. 2, the computing system 200 may include an enterprise application 126, a web server 124, a demo application 108, intelligent screen capture (ISC) utility 232, and/or another application, depending on the configuration. For instance, a client device 106 may include or execute a demo application 108 (which could incorporate various aspects of the enterprise application 126, in some implementations); and the management server 122 may include the web server 124, the enterprise application 126, and/or components thereof, although other configurations are also possible and contemplated.

The enterprise application 126 includes computer logic executable by the processor 204 to perform operations discussed elsewhere herein. The enterprise application 126 may be coupled to the data storage device 208 to store, retrieve, and/or manipulate data stored therein and may be coupled to the web server 124, the demo application 108, and/or other components of the system 100 to exchange information therewith.

The web server 124 includes computer logic executable by the processor 204 to process content requests (e.g., to or from a client device 106). The web server 124 may include an HTTP server, a REST (representational state transfer) service, or other suitable server type. The web server 124 may receive content requests (e.g., product search requests, HTTP requests) from client devices 106, cooperate with the enterprise application 126 to determine the content, retrieve and incorporate data from the data storage device 208, format the content, and provide the content to the client devices 106.

In some instances, the web server 124 may format the content using a web language and provide the content to a corresponding demo application 108 for processing and/or rendering to the user for display. The web server 124 may be coupled to the data storage device 208 to store retrieve, and/or manipulate data stored therein and may be coupled to the enterprise application 126 to facilitate its operations.

The demo application 108 includes computer logic executable by the processor 204 on a client device 106 to provide for user interaction, receive user input, present information to the user via a display, and send data to and receive data from the other entities of the system 100 via the network 102. In some implementations, the demo application 108 may generate and present user interfaces based on information received from the enterprise application 126, third-party server 118, and/or the web server 124 via the network 102. For example, a stakeholder/user may use the demo application 108 to perform the operations described herein.

In some implementations, an intelligent screen capture (ISC) utility 232 may be included in, with, or separate to the demo application 108. This may be a separate service on a separate device or integrated into the demo application 108. For example, the ISC utility 232 may perform operations described herein. In some implementations, the ISC utility 232 may be an extension of a web browser.

As depicted, the computing system 200 may include a processor 204, a memory 206, a communication unit 202, an output device 216, an input device 214, and a data storage device 208, which may be communicatively coupled by a communication bus 210. The computing system 200 depicted in FIG. 2 is provided by way of example and it should be understood that it may take other forms and include additional or fewer components without departing from the scope of the present disclosure. For instance, various components of the computing devices may be coupled for communication using a variety of communication protocols and/or technologies including, for instance, communication buses, software communication mechanisms, computer networks, etc. While not shown, the computing system 200 may include various operating systems, sensors, additional processors, and other physical configurations. The processor 204, memory 206, communication unit 202, etc., are representative of one or more of these components.

The processor 204 may execute software instructions by performing various input, logical, and/or mathematical operations. The processor 204 may have various computing architectures to method data signals (e.g., CISC, RISC, etc.). The processor 204 may be physical and/or virtual and may include a single core or plurality of processing units and/or cores. In some implementations, the processor 204 may be coupled to the memory 206 via the bus 210 to access data and instructions therefrom and store data therein. The bus 210 may couple the processor 204 to the other components of the computing system 200 including, for example, the memory 206, the communication unit 202, the input device 214, the output device 216, and the data storage device 208.

The memory 206 may store and provide access to data to the other components of the computing system 200. The memory 206 may be included in a single computing device or a plurality of computing devices. In some implementations, the memory 206 may store instructions and/or data that may be executed by the processor 204. For example, the memory 206 may store one or more of the enterprise application 126, the web server 124, the demo application 108, the ISC utility 232, and/or their respective components, depending on the configuration. The memory 206 is also capable of storing other instructions and data, including, for example, an operating system, hardware drivers, other software applications, databases, etc. The memory 206 may be coupled to the bus 210 for communication with the processor 204 and the other components of computing system 200.

The memory 206 may include a non-transitory computer-usable (e.g., readable, writeable, etc.) medium, which can be any non-transitory apparatus or device that can contain, store, communicate, propagate or transport instructions, data, computer programs, software, code, routines, etc., for processing by or in connection with the processor 204. In some implementations, the memory 206 may include one or more of volatile memory and non-volatile memory (e.g., RAM, ROM, hard disk, optical disk, etc.). It should be understood that the memory 206 may be a single device or may include multiple types of devices and configurations.

The bus 210 can include a communication bus for transferring data between components of a computing device or between computing devices, a network bus system including the network 102 or portions thereof, a processor mesh, a combination thereof, etc. In some implementations, the enterprise application 126, web server 124, demo application 108, and various other components operating on the computing system/device 200 (operating systems, device drivers, etc.) may cooperate and communicate via a communication mechanism included in or implemented in association with the bus 210. The software communication mechanism can include and/or facilitate, for example, inter-method communication, local function or procedure calls, remote procedure calls, an object broker (e.g., CORBA), direct socket communication (e.g., TCP/IP sockets) among software modules, UDP broadcasts and receipts, HTTP connections, etc. Further, any or all of the communication could be secure (e.g., SSH, HTTPS, etc.).

The communication unit 202 may include one or more interface devices (I/F) for wired and wireless connectivity among the components of the system 100. For instance, the communication unit 202 may include, but is not limited to, various types known connectivity and interface options. The communication unit 202 may be coupled to the other components of the computing system 200 via the bus 210. The communication unit 202 can provide other connections to the network 102 and to other entities of the system 100 using various standard communication protocols.

The input device 214 may include any device for inputting information into the computing system 200. In some implementations, the input device 214 may include one or more peripheral devices. For example, the input device 214 may include a keyboard, a pointing device, a mouse, microphone, an image/video capture device (e.g., camera), a touchscreen display integrated with the output device 216, etc. The output device 216 may be any device capable of outputting information from the computing system 200. The output device 216 may include one or more of a display (LCD, OLED, etc.), a printer, a haptic device, audio reproduction device, touch-screen display, a remote computing device, etc. In some implementations, the output device is a display which may display electronic images and data output by a processor of the computing system 200 for presentation to a user, such as the processor 204 or another dedicated processor.

The data storage device 208 may include one or more information sources for storing and providing access to data. In some implementations, the data storage device 208 may store data associated with a database management system (DBMS) operable on the computing system 200. For example, the DBMS could include a structured query language (SQL) DBMS, a NoSQL DMBS, various combinations thereof, etc. In some instances, the DBMS may store data in multi-dimensional tables comprised of rows and columns, and manipulate, e.g., insert, query, update and/or delete, rows of data using programmatic operations.

The data stored by the data storage device 208 may be organized and queried using various criteria including any type of data stored by them, such as described herein. For example, the data storage device 208 may store the database 128. The data storage device 208 may include data tables, databases, or other organized collections of data. Examples of the types of data stored by the data storage device 208 may include, but are not limited to, the data described with respect to the figures, for example, the data may include user accounts, media segments, images, demonstration presentations, UI elements, media, topic data, topic cards, administrative roles, user roles, etc.

The data storage device 208 may be included in the computing system 200 or in another computing system and/or storage system distinct from but coupled to or accessible by the computing system 200. The data storage device 208 can include one or more non-transitory computer-readable mediums for storing the data. In some implementations, the data storage device 208 may be incorporated with the memory 206 or may be distinct therefrom.

The components of the computing system 200 may be communicatively coupled by the bus 210 and/or the processor 204 to one another and/or the other components of the computing system 200. In some implementations, the components may include computer logic (e.g., software logic, hardware logic, etc.) executable by the processor 204 to provide their acts and/or functionality. In any of the foregoing implementations, the components may be adapted for cooperation and communication with the processor 204 and the other components of the computing system 200.

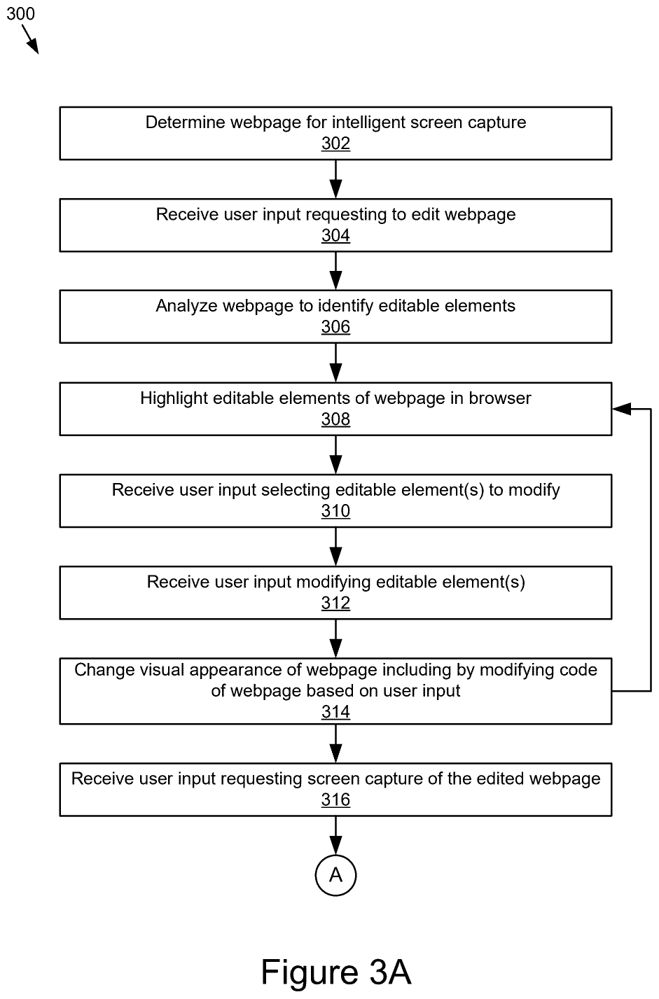

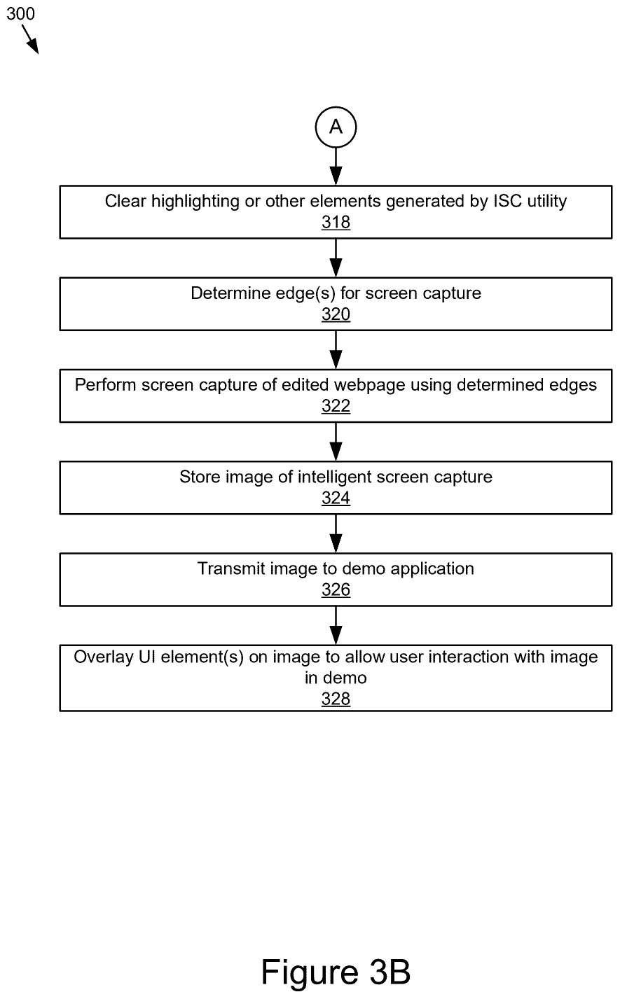

FIGS. 3A and 3B illustrate a flowchart of example method 300, which provides operations for intelligently creating edited screen captures and/or creating and using a digital demonstration presentation, as described elsewhere herein. The operations may be used in addition to or alternative from those other described herein, such as those described above or in reference to the example graphical user interfaces illustrated and described herein. It should be noted that although certain operations are described, the particular operations may be augmented, removed, reordered, or otherwise modified without departing from the scope of this disclosure.

At 302, the ISC utility 232 may determine a webpage, image, or other graphical page for intelligent screen capture. For example, a user may navigate to a webpage on a web browser and use the ISC utility 232 to perform an intelligent screen capture (or other image of a webpage). The ISC utility 232 may identify the active webpage or window. In some cases, the ISC utility 232 may include a plugin to a web browser or another program that captures images of webpages, another application (e.g., other than a browser), or another portion of a computer display.

For example, a user may activate a screen capture button on a graphical user interface of the ISC utility 232 while a particular window, browser, tab, webpage, or otherwise are active, or the user may select a screen capture button and then select the window, tab, webpage, etc., to indicate that the user wishes to capture it. In some cases, the ISC utility 232 may include a plugin, extensions, or other code that interfaces with a browser to automatically select an active webpage.

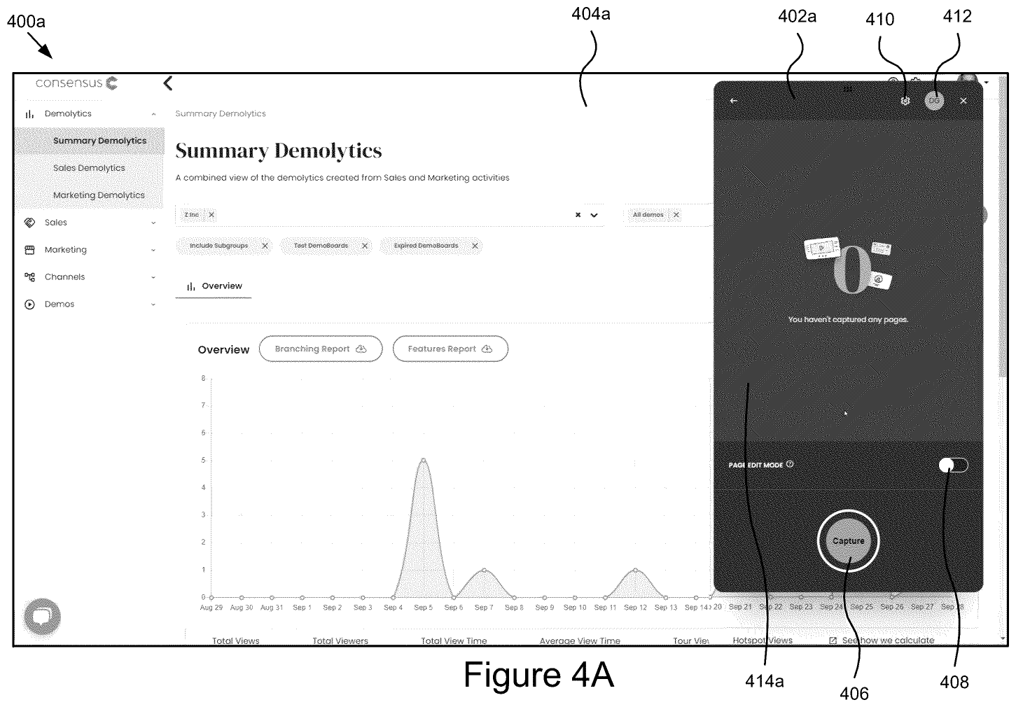

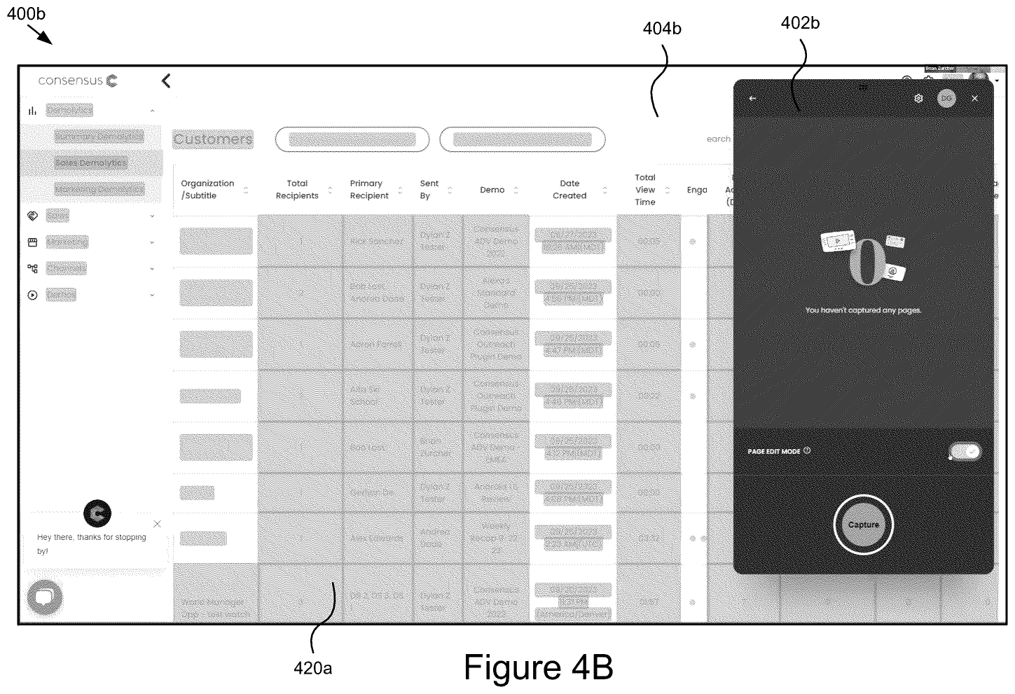

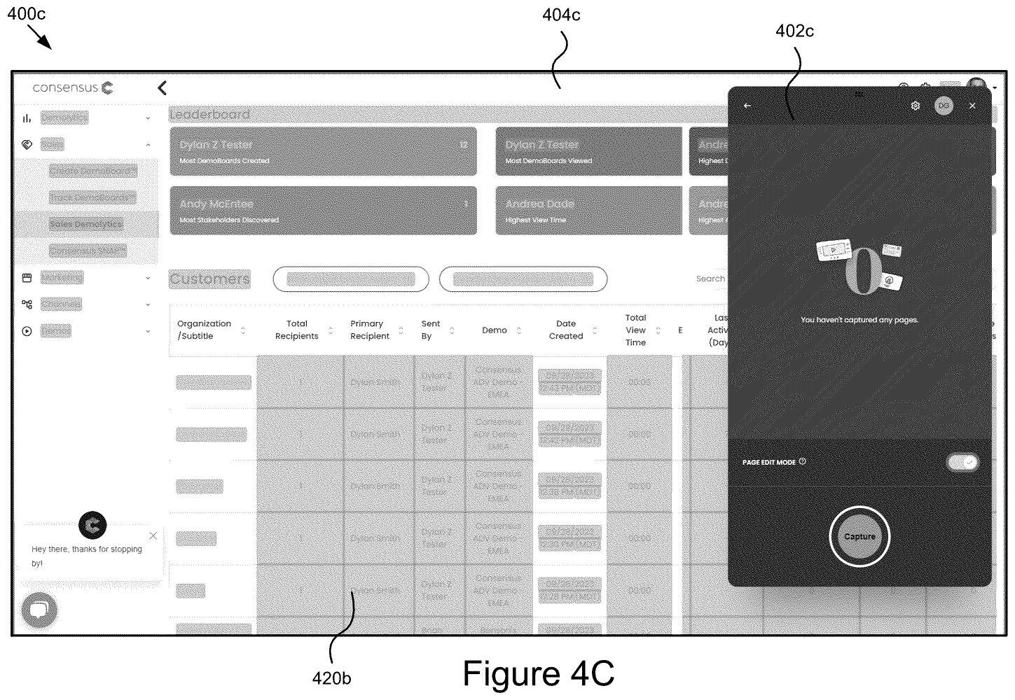

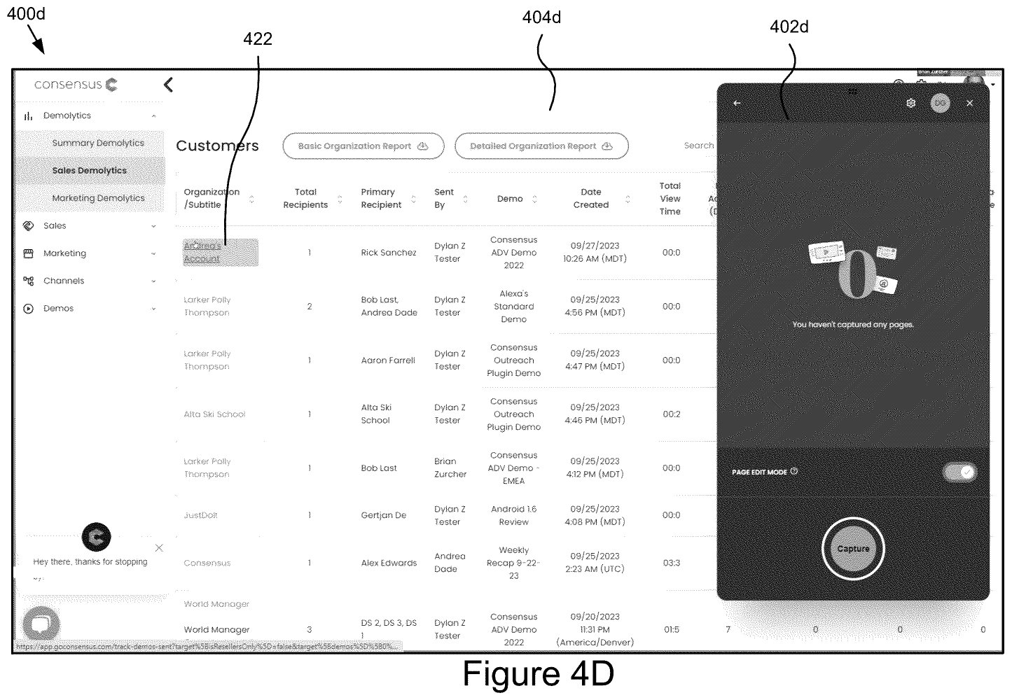

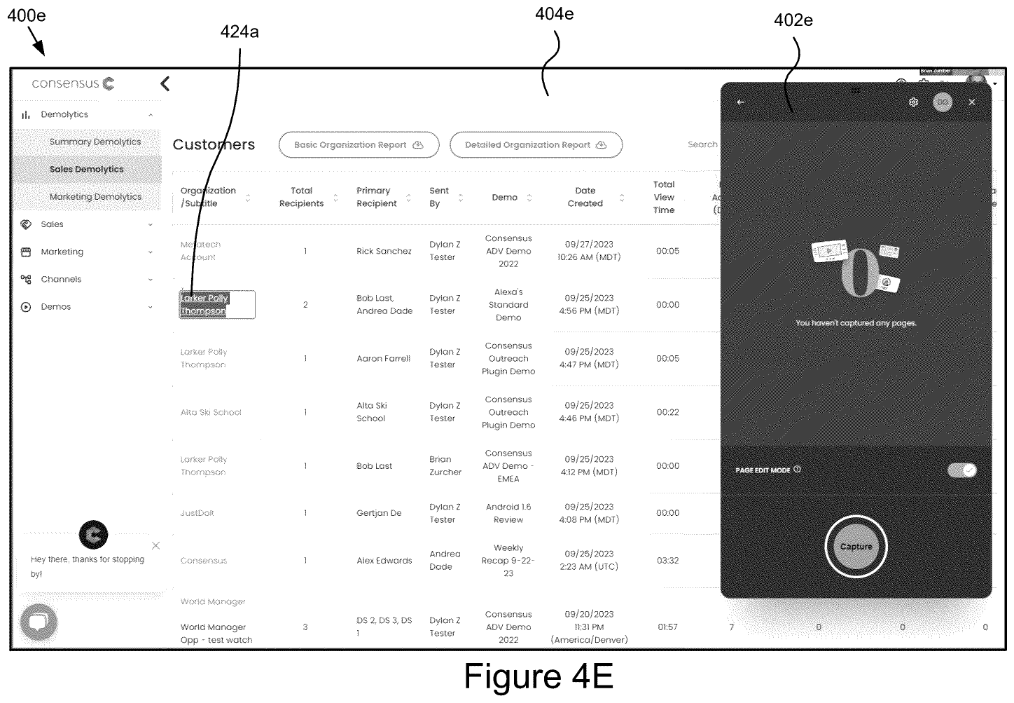

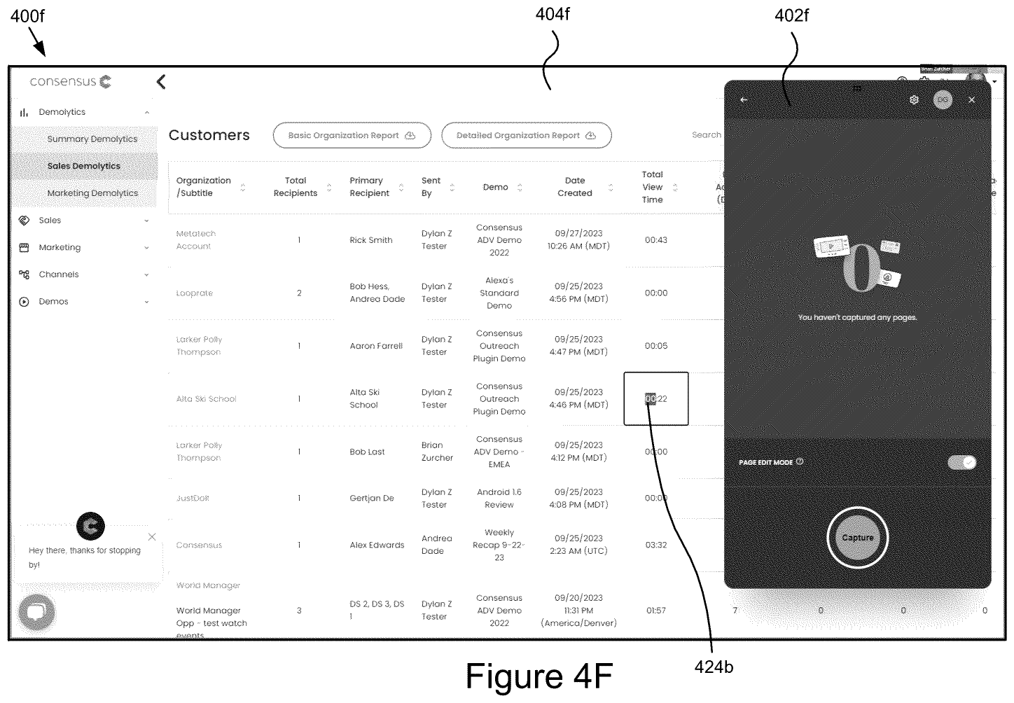

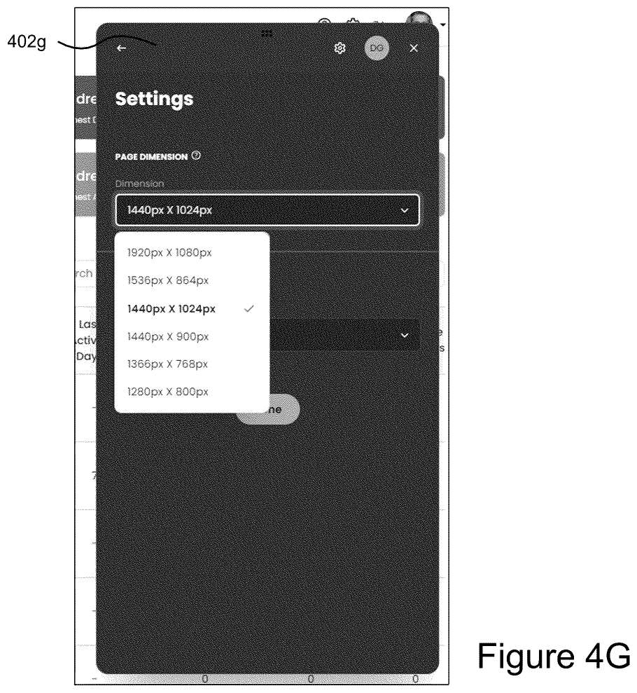

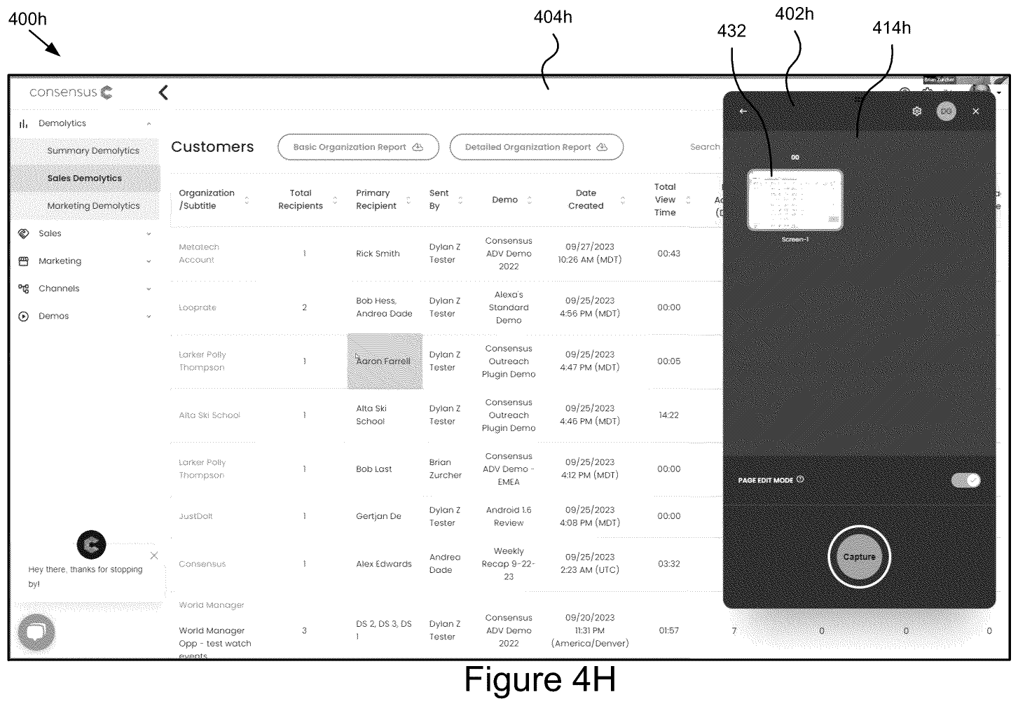

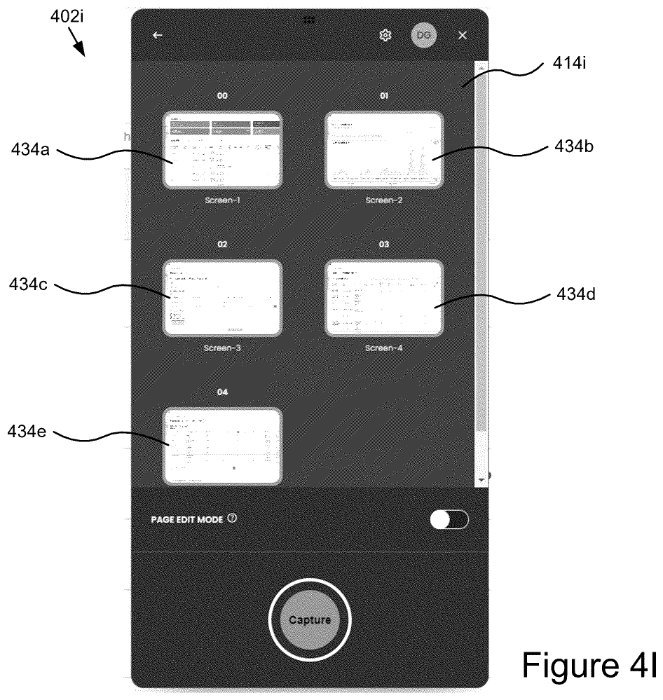

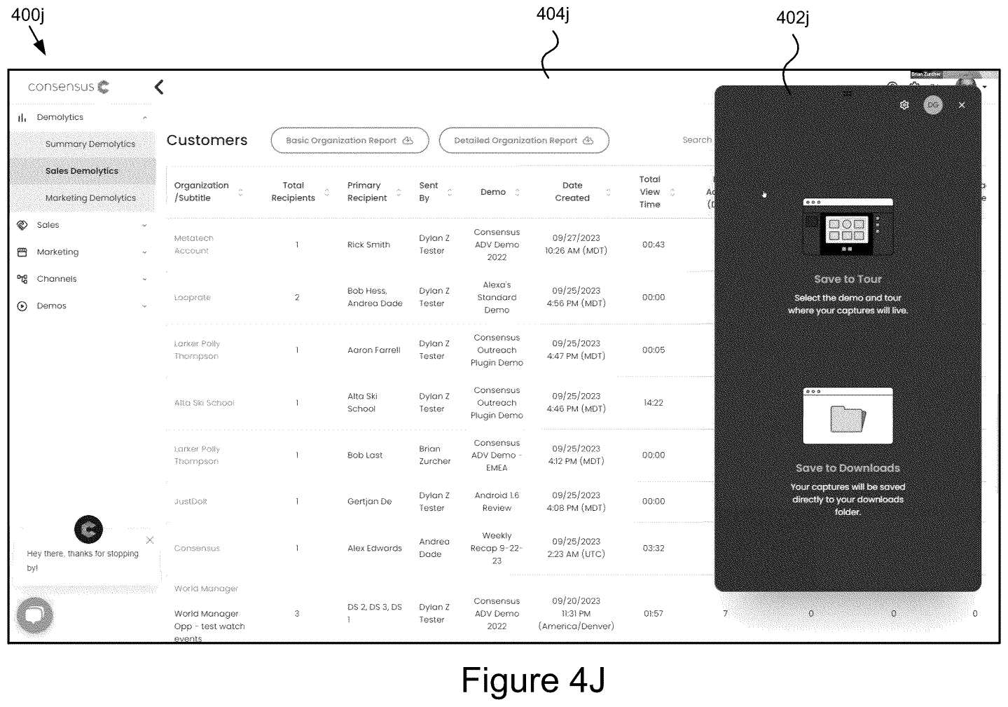

For example, FIG. 4A illustrates an example graphical user interface 400a in which shows a graphical user interface 402a for an ISC utility 232 overlayed on a page 404a, which may be a webpage displayed in a browser, although other implementations are possible. For instance, a user may select the ISC utility 232 in a browser and, in response, the ISC utility 232 may display the interface 402a separate to or overlayed on the page 404a.

As an example, the interface 402a may include a capture button 406, a switch 408 for page edit mode, a settings button 410, a login or user profile button 412, and/or an image preview panel 414a. The capture button 406 may initiate an image capture and or page editing function, for example based on the switch 408. The settings button 410 may allow the user to set image size, editing preferences, a connection to a demo application 108, or other settings. The login or user profile button 412 may display a user's profile and/or may allow the user to login to allow images (edited or unedited) to be saved to a cloud storage (e.g., the database 128) associated with that user. In some instances, the login or user profile button 412 may allow the user to define a connection to a demo application 108 or user profile associated with the demo application 108 or management server 122, for example.

As described in further detail elsewhere herein, the preview panel 414a may display thumbnails or previews of captured images, pre-edited captured images, etc., which may be stored locally and/or on a cloud storage. These previews may be selected to display, edit, or add them to a demo of on a demo application.

Referring to FIG. 3A, at 304, the ISC utility 232 may receive a user input requesting to edit the webpage or other window, etc., depending on the implementation. For instance, the ISC utility 232 may receive a user selection of a button to edit the webpage. The ISC utility 232 may display, in a graphical user interface, a graphical switch (e.g., 408 in FIG. 4A) indicating whether or not to edit a page. In some implementations, after actuating the capture button, the ISC utility 232 may automatically provide functionality for editing the page or it may request user input regarding whether to edit the page. In some implementations, the ISC utility 232 may capture an image before and after edits to the page.

At 306, the ISC utility 232 may analyze the webpage to identify editable elements. In some implementations, the ISC utility 232 may access the HTML or DOM of the webpage to identify text, images, or other objects. For example, the ISC utility 232 may access the HTML elements or properties of the page and may identify content areas, images, graphics, or text, etc., from the code.

At 308, the ISC utility 232 may indicate the editable elements on the webpage in the browser. The editable elements may be indicated based on the interface ISC utility 232 or associated interface or button being selected, based on a dedicated button being selected, or based on a capture button being selected, for instance. For example, the ISC utility 232 may overlay highlighting, boxes, or otherwise draw attention to elements visual objects on the displayed webpage matching editable elements in the code of the webpage. In some implementations, the highlighting of elements may persist temporarily for a defined time period or may persist until a user makes an edit or captures an image. In some instances, some or all of the editable elements may be indicated on the webpage, which may include only those that are visible, or it may include all elements (e.g., those scrolled out of view) on the webpage.

FIGS. 4B and 4C illustrate example graphical user interfaces 400b and 400c, respectively, in which the ISC utility 232 has determined and highlighted editable elements of the page 404b and 404c, respectively (e.g., in response to a user switching on “page edit mode”). Similar to FIG. 4A, an interface 402b or 402c may be displayed for the ISC utility 232.

Each of FIGS. 4B and 4C illustrate the ISC utility 232 indicating, for example, via highlighted boxes, content regions that may be edited. In some instances, larger content regions 420a and 420b (respectively in FIGS. 4B and 4C) surrounding editable text may be highlighted briefly and then the highlighting may be removed or replaced with less pronounced highlighting, or it may be highlighted only when hovered over by the user (e.g., by a cursor). As illustrated, the highlighted regions 420 may indicate editable text regions, although other implementations are possible and contemplated herein. The regions 420 may be in a side bars, menus, graphs, text bodies, etc., and may be currently displayed or hidden on the page 404.

Referring to FIG. 3A, at 310, the ISC utility 232 may receive a user input selecting an editable element to modify. For instance, the user may click or hover over an object, such as text or an image on the page matching the editable elements from the code. In response to the hover or click, the ISC utility 232 may again highlight or otherwise indicate the editable element or that it is being edited.

For example, FIG. 4D illustrates an example graphical user interface 400d of a page 404d with an ISC utility 232 interface 402d overlayed. As shown, a cursor is hovering over an editable element, which the ISC utility 232 (either separately or using the browser) may represent using a box or other highlighting at 422. As the cursor hovers over various elements of the page 404d, they may be highlighted to indicate which elements are editable (e.g., some graphics, etc., may not be editable by the ISC utility 232, as determined based on the code of the page).

Referring to FIG. 3A, at 312, the ISC utility 232 may receive a user input modifying the editable element. For example, where the user has selected text to edit in on the displayed webpage, the ISC utility 232 may display, in place of the editable text, a text input field, allow the user to select and edit the text, or may display a separate text entry or editing field. For example, the ISC utility 232 may receive text and edit the DOM/HTML/code of the webpage to modify its visual appearance.

For example, FIG. 4E illustrates an example graphical user interface 400e of a page 404e with an ISC utility 232 interface 402e overlayed. As shown, the ISC utility 232 may allow a user to select and/or edit text on the page 404e. For instance, a user may type new text into the editable element 424a, which may cause the ISC utility 232, for instance, to edit the code of the page 404e. FIG. 4F illustrates an example graphical user interface 400f of a page 404f with and ISC utility 232 interface 402f overlayed. As shown, the editable element 424b may be used to edit the page 404f. In some implementations, the page 404 may be displayed with the updates once the user is no longer editing them or when an image is captured, for instance.

Referring to FIG. 3A, at 314, the ISC utility 232 may change a visual appearance of the webpage, which may include, for instance, modifying the code of the webpage based on the user input. For example, text in the webpage's code may be modified where text was changed on the webpage by the user using the ISC utility 232. In some instances, images, graphics, or other objects may be modified by changing a link, uploading a different image, or otherwise, which the ISC utility 232 may use to replace selected page elements. Accordingly, in some instances, the appearance of the webpage may be modified at a front end without modifying the back-end data provided by a web server.

At 316, the ISC utility 232 may receive a user input requesting a screen capture of the edited webpage. For example, the ISC utility 232 may receive, via a graphical button (e.g., 406 on FIG. 4A) on a graphical user interface, to capture the screen, page, window, or other image, such as the displayed portion of a tab of a web browser. In some implementations, the ISC utility 232 may allow the user to modify the resolution or dimensions of the webpage and, thereby, the screen capture image.

At 318, the ISC utility 232 may clear highlighting or other elements generated by the ISC utility 232. For instance, where the ISC utility 232 is displaying any highlighting indicating edited or editable elements, it may clear or hide these elements prior to or briefly while capturing an image of the screen. Similarly, where a graphical user interface (e.g., 402) of the ISC utility 232 is displayed on the screen, the screen capture may be performed of the webpage under or in absence of the ISC utility's graphical user interface.

In some implementations, at 320, the ISC utility 232 may determine one or more edges for the screen capture image. The edges may be the displayed edges of an active tab in a web browser, the entire screen, a defined resolution/shape, or other defined area. For example, the edges may be based on the resolution determined before or after requesting that the image be captured.

For example, FIG. 4G illustrates an example graphical user interface 402g (e.g., displayed based on selection of a settings button or other element) in which a dimension or resolution of a screen capture is defined (e.g., based on a dropdown or other input element). In some implementations, in response to changing the dimensions, the ISC utility 232 may automatically resize the browser window to match the defined dimension. In some implementations, the image, after it is captured, may be scaled based on the defined dimension. In some implementations, an aspect ratio instead of a resolution may be selected. In some implementations, the ISC utility 232 may automatically select the visible corners of the page 404 or allow the user to select a border of an application, window, page, etc., which dimensions or resolutions may be used. In some implementations, the resolution of the image may be linked to or separate from the resolution of the display of the client device 106 on which the page is being displayed. In some implementations, the ISC utility 23 may temporarily resize the page being captured within or beyond the boundaries of the display to match the defined resolution. In some instances, the edges may be beyond the visible boundaries of the page, for example, where the image includes a scrolled portion of the page or where the page is larger than a display.

Referring to FIG. 3B, at 322, the ISC utility 232 may perform the image capture of the edited page using the determined edges. For example, the image may be a screengrab or pixel-by-pixel reproduction of a webpage as it appears in an active or top-most window of a browser, although other implementations are possible, as noted elsewhere herein.

At 324, the ISC utility 232 may store the image of the intelligent capture in a local data storage device (e.g., 208) and/or a cloud storage device (e.g., 128). A graphical user interface of the ISC utility 232 may display the image or a thumbnail/preview thereof. In some cases, ISC utility 232 may automatically store the image in a downloads folder, desktop folder, or other defined folder on a computer.

FIG. 4H illustrates an example graphical user interface 400h in which a graphical user interface 402h of the ISC utility 232 (overlayed on a page 404h) includes a thumbnail 432 representing a captured image in an image preview region 414h, which may be stored in a dedicated folder, in downloads, in a temporary folder, etc.

FIG. 4I illustrates an example graphical user interface 402i in which multiple thumbnails 434a, 434b, 434c, 434d, and 434e are displayed in an image preview region 414i and which represent a set or series of captured images. In some instances, multiple images may be captured by the ISC utility 232 of a webpage while maintaining the edits, edits may be made between captures, or edits may be reset between captures. In some cases, the edits may persist as a page is scrolled down or changes, for instance, where the user scrolls down a webpage in a browser and captures another image with the visible edits persistent and/or new edits made as described above.

Referring to FIG. 3B, at 326, the ISC utility 232 may transmit the intelligent screen capture image to the demo application. For example, where the ISC utility 232 is part of the demo application 108 or communicates therewith (e.g., with an API), etc., the ISC utility 232 may automatically insert the image into a demo. In some implementations, a digital demo presentation may be based on a series of images and the ISC utility 232 may insert a captured image directly into an active or defined demo being built.

In some implementations, at 328, the ISC utility 232 and/or a demo application 108 may overlay one or more UI elements, such as hotspots or HTML boxes, over one or more images, such as the captured image(s). These UI elements may allow user interaction with the image in a demo. In some implementations, an interactable UI element may include user-defined HTML associated with a defined location on the image, which may be executed to simulate interaction with the image by an end user exploring the demo.

FIG. 4J illustrates an example graphical user interface 400j in which a graphical user interface 402j of the ISC utility 232 is displayed over a page 404j. The ISC utility 232 may provide options for how images are handled automatically or manually once captured. For instance, the ISC utility 232 may allow images to be directly imported into a demo application 108, downloaded to a defined folder, or otherwise. In some cases, a user may select (e.g., hold, left click, right click, hover over, etc.) an image preview (e.g., 434a in FIG. 4I) and the ISC utility 232 may ask the user what to do with the image, such as send it to a demo application 108 or save it to a defined location. In some cases, these options may be determined when the ISC utility 232 is first launched, when an image is captured, or based on selection of a settings button.

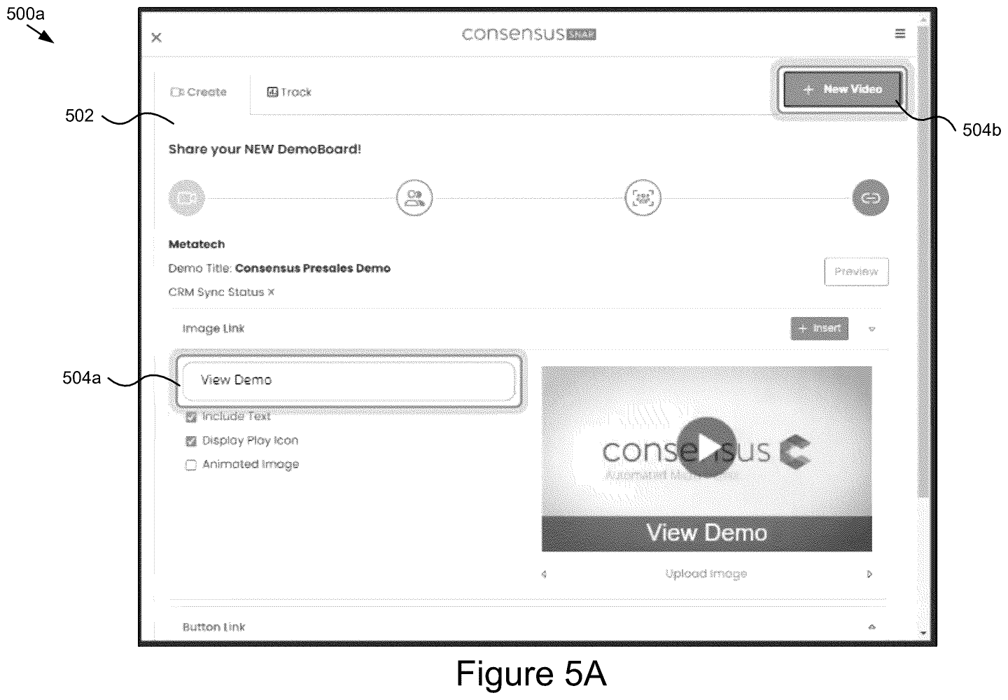

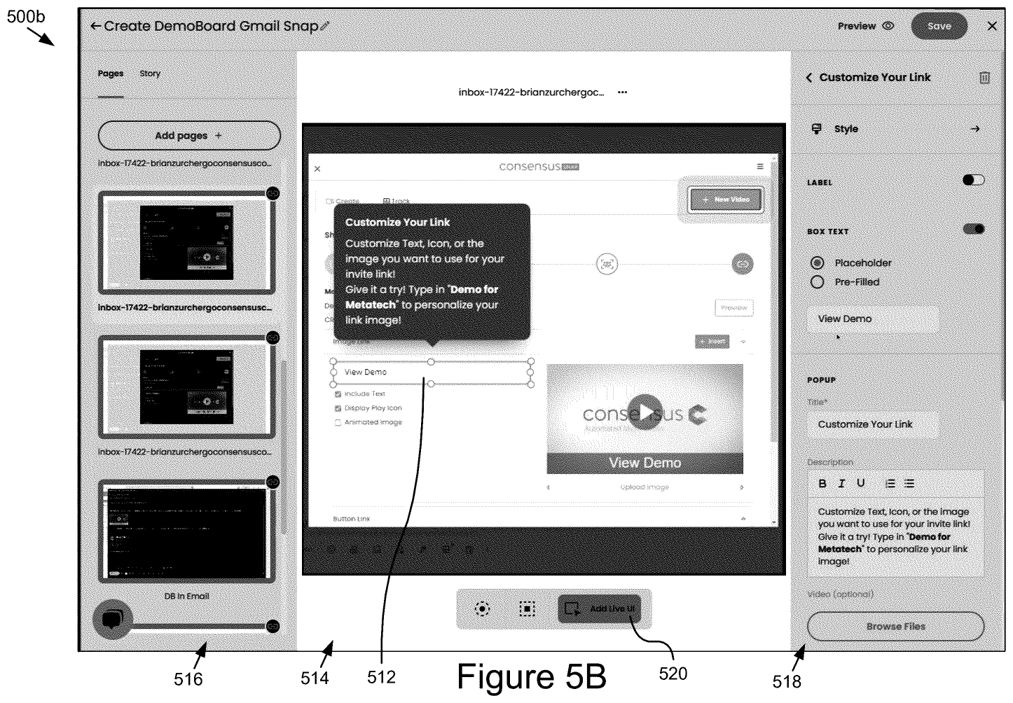

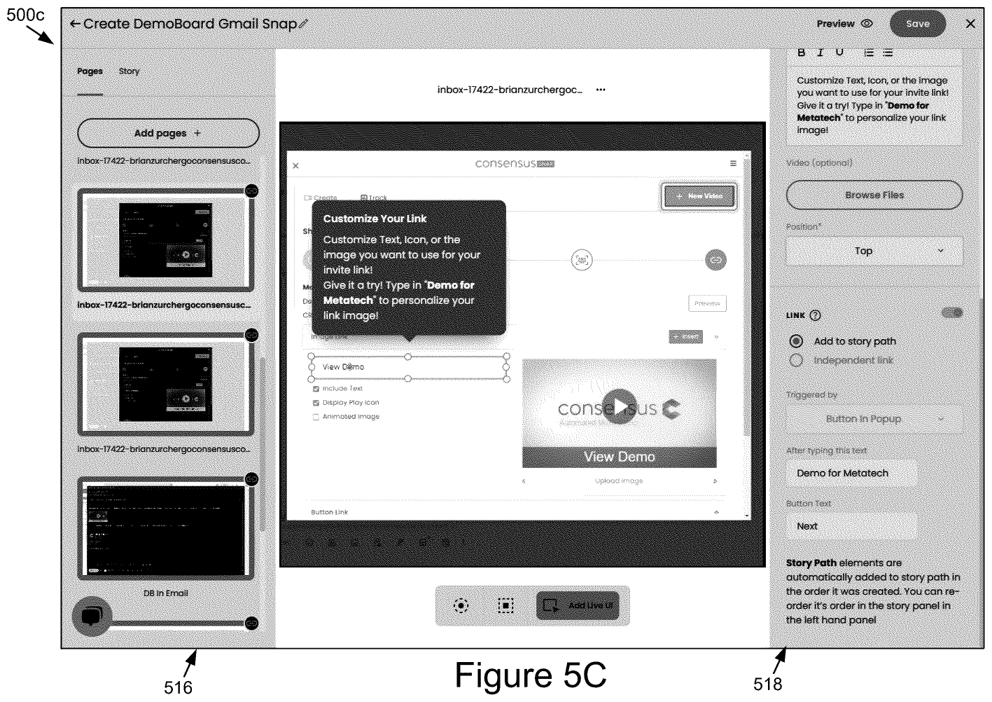

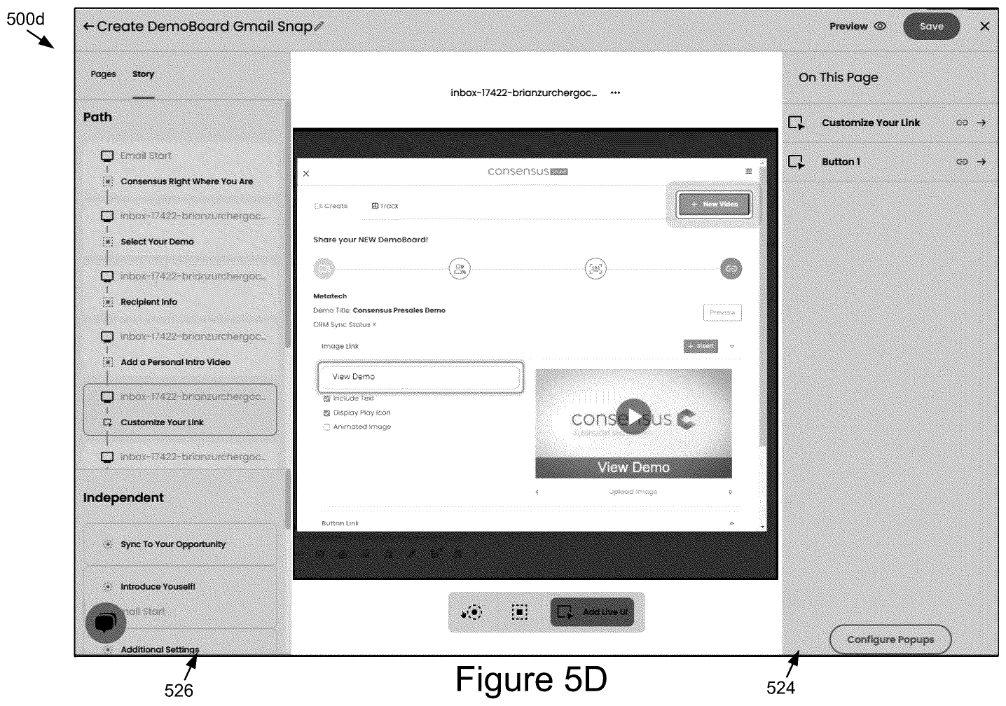

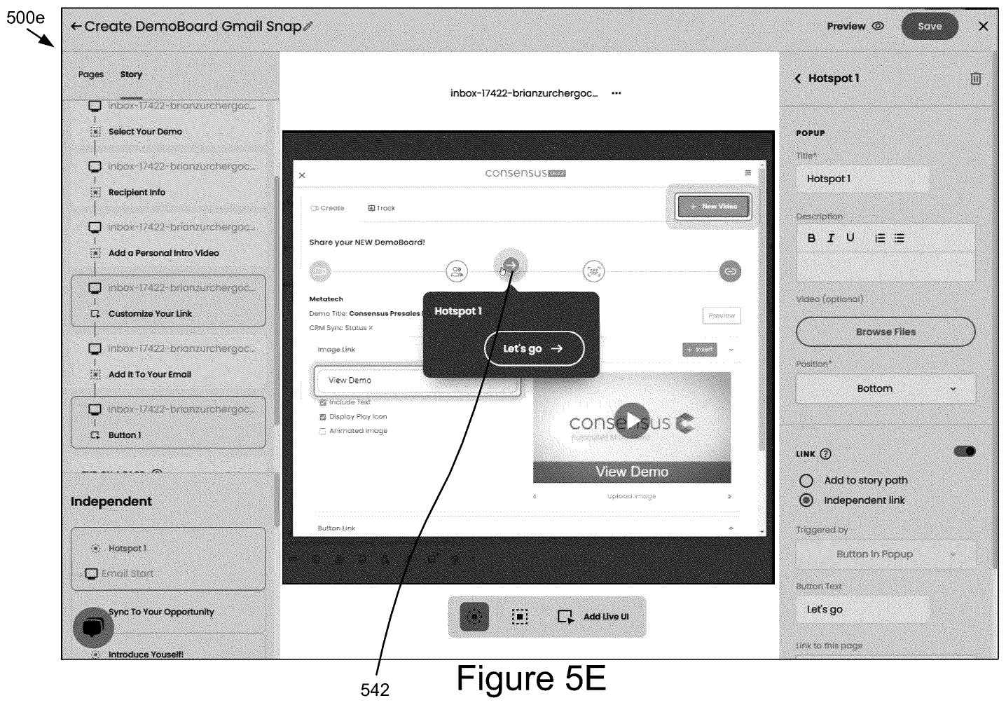

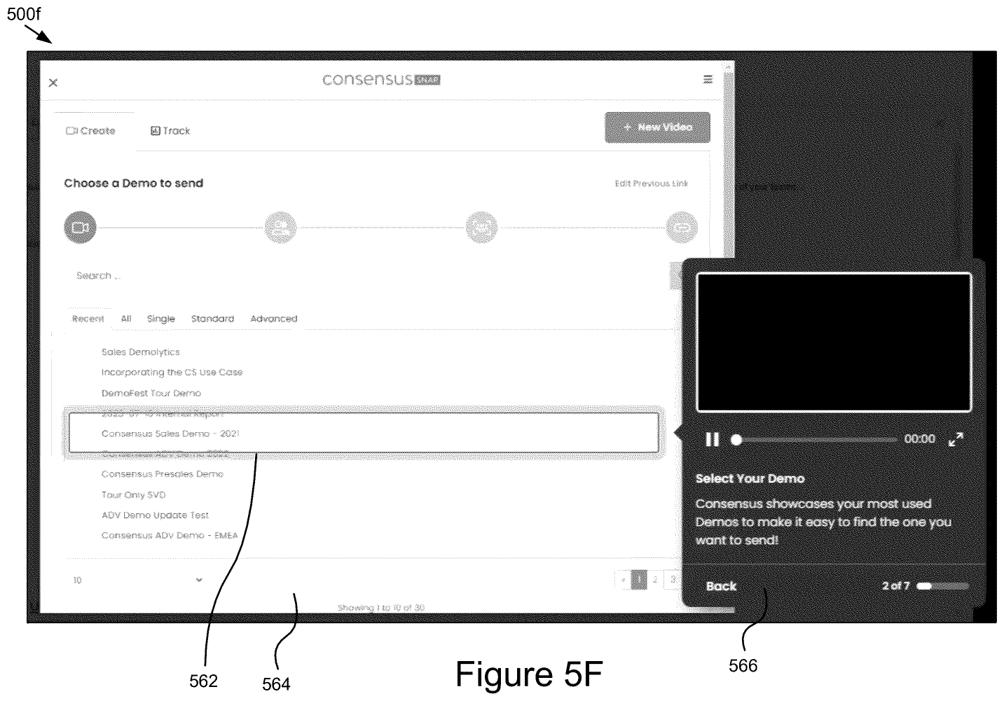

FIG. 5A illustrates an example graphical user interface 500a showing a demonstration presentation (e.g., a demo of the demo application 108) is displayed. In the depicted example, an image 502 is displayed, which includes various text and graphics. The image may have been captured as noted above in reference to FIGS. 3A and 3B. As illustrated, two UI elements 504a and 504b (e.g., at the New Video and View Demo buttons), which may be highlighted during configuration or use of the demo by bounding boxes or other graphical elements. In some implementations, the bounding boxes may be animated to change intensity, grow/shrink, or otherwise to further draw attention to them. For example, the View Demo UI element at 504a may be selected to show and/or select a demo. These UI elements may be overlayed over the image 502 as a background, so that the appearance is consistent with the captured page, window, application, etc., but so that a user may interact with the UI elements. As noted in further detail below, a UI element may be overlayed on the image and defined to perform actions, which may correspond to elements of the captured page. The live UI elements may be manually defined by a user after having captured an image of a page, although other implementations and automations are possible.

FIG. 5B illustrates an example graphical user interface 500b displayed by a demo application 108 in which a live UI element, such as a text-input field, is defined. A boundary 512 for the field may be defined relative to a selected image, and other attributes may be defined. For example, a style, whether the field is pre-filled or receives text, a title, description (e.g., displayed when the field is selected), link to media, or other details, as illustrated elsewhere, may be defined. As shown in FIG. 5B, the interface 500b may include a preview region 514 illustrating an example demo presentation, for example, for a particular page (e.g., a captured image with overlayed UI elements). The interface 500b may also include a navigation bar 516 in which a set or series of pages may be organized into a presentation.

The boundary 512 be a box that is positioned on top of an image, and which may block out portions of the image. In some instances, in production, the boundary 512 may also be highlighted, colored, or otherwise emphasized to indicate to the user a portion of the demo with which the user may interact. In some implementations, a user may define a location or boundary 512 of a UI element in the preview region 514.

The interface 500b may also include a configuration bar 518, which may include various graphical elements for defining attributes of a UI element. For instance, the configuration bar 518 may allow a user to define a style, label, text (e.g., placeholder or pre-filled), a popup title and description, video, a file, other attributes, or other information associated with a UI element. The UI element may also or alternatively have navigation properties, which cause other UI elements and/or other pages in a demo to be displayed, highlighted, navigated to, activated, or otherwise.

In some implementations, the preview region 514 or other portion of the interface 500b may include an add UI element button 520 that allows various UI elements to be added to a page, demo, or timeline/story of the demo.

FIG. 5C illustrates an example graphical user interface 500c, which may correspond to the example graphical user interface 500b in which the configuration bar 518 is scrolled down to show further options for defining the UI element, such as a text-input field, for example to define whether the UI element is in the story path or is independent. As shown in the example, the configuration bar 518 may allow a position for the UI element, whether the UI element is inside of or independent of a story path of a demo, how the UI element may be triggered (by a previous UI element, display of a page, by a button in a popup, or other trigger), what happens after interaction with the UI element, or other details. As an example, for a story path of a demo presentation, pages or UI elements within the story path may be automatically added to a sequence of steps in the order in which the live UI element was created, though it can be re-ordered in the story panel/navigation bar 516.

In some cases, a UI element may have logic, for example, where it includes a button, drop down, or allows multiple different text inputs, and the configuration bar 518 may allow the logic and interaction between UI elements to be defined.

FIG. 5D illustrates an example graphical user interface 500d in which a story path is graphically represented on a side panel 526, which may correspond to the navigation panel 516. For example, a story path with pages, UI elements, etc., may be displayed and/or edited in addition to or in place of a set of demo pages. For instance, the images, UI elements, and other data may be displayed for a selected page or for the entire demo. Independent elements, which may be UI elements, pages, etc., not automatically displayed or linked within the story path, may also be displayed. It should be noted that demo pages may be different from the pages discussed in reference to FIGS. 3A and 3B.

In some cases, a second graphical panel 524 may display specifically those UI elements on the displayed demo page, and they may be used to reorder or redefine the UI elements. For example, where the UI elements are or include buttons, links, or popups, the buttons, links, or popups may be defined.

FIG. 5E illustrates an example graphical user interface 500e in which a hotspot 542 is defined within the context of a story path. A hotspot 542, for example, may be an element (visible or not) overlayed on a demo page which may be selected or hovered over to display a popup, which may have information or other buttons, logic, etc. For instance, an attribute of the hotspot 542 indicating whether the hotspot 542 is in the story path or is independent from the path may be manually defined by an administrator (e.g., a user having a role or account for creating a demo). As noted above, where UI elements are added to the story path, they may be automatically added in the order in which they are created, but they may be reordered.

FIG. 5F illustrates an example graphical user interface 500f in which a demo is displayed to a user. In the example, a rectangular hotspot/UI element 562 is shown highlighting an area on the image 564. When the hotspot 562 is selected (e.g., clicked, hovered over, or automatically selected based on a sequence of steps in the story path), a popup 566 showing a title, description and other information may be displayed on the interface. For example, the popup 566 may include a video, a navigation element showing or allowing navigation backward or forward in the story path may be shown. Similarly, in some instances, the popup 566 may show a current position in percentage or step number of in the story path.

It should be noted that other operations, orders, and features are contemplated herein. For instance, the technology may use fewer, additional, or different operations or orders of operations than those described herein without departing from the scope of this disclosure. It should be noted that although the operations of the method 300 are described in reference to the demo application 108, they may be performed by different components of the system 100, distributed, or otherwise modified without departing from the scope of this disclosure.

In the above description, for purposes of explanation, numerous specific details are set forth in order to provide a thorough understanding of the present disclosure. However, it should be understood that the technology described herein can be practiced without these specific details. Further, various systems, devices, and structures are shown in block diagram form in order to avoid obscuring the description. For instance, various implementations are described as having particular hardware, software, and user interfaces. However, the present disclosure applies to any type of computing device that can receive data and commands, and to any peripheral devices providing services.

In some instances, various implementations may be presented herein in terms of algorithms and symbolic representations of operations on data bits within a computer memory. An algorithm is here, and generally, conceived to be a self-consistent set of operations leading to a desired result. The operations are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

To ease description, some elements of the system 100 and/or the methods are referred to using the labels first, second, third, etc. These labels are intended to help to distinguish the elements but do not necessarily imply any particular order or ranking unless indicated otherwise.

It should be borne in mind, however, that all of these and similar terms are to be associated with the appropriate physical quantities and are merely convenient labels applied to these quantities. Unless specifically stated otherwise as apparent from the following discussion, it is appreciated that throughout this disclosure, discussions utilizing terms including “processing,” “computing,” “calculating,” “determining,” “displaying,” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

Various implementations described herein may relate to an apparatus for performing the operations herein. This apparatus may be specially constructed for the required purposes, or it may comprise a general-purpose computer selectively activated or reconfigured by a computer program stored in the computer. Such a computer program may be stored in a computer readable storage medium, including, but is not limited to, any type of disk including floppy disks, optical disks, CD-ROMs, and magnetic disks, read-only memories (ROMs), random access memories (RAMs), EPROMs, EEPROMs, magnetic or optical cards, flash memories including USB keys with non-volatile memory or any type of media suitable for storing electronic instructions, each coupled to a computer system bus.

The technology described herein can take the form of an entirely hardware implementation, an entirely software implementation, or implementations containing both hardware and software elements. For instance, the technology may be implemented in software, which includes but is not limited to firmware, resident software, microcode, etc. Furthermore, the technology can take the form of a computer program product accessible from a computer-usable or computer-readable medium providing program code for use by or in connection with a computer or any instruction execution system. For the purposes of this description, a computer-usable or computer readable medium can be any non-transitory storage apparatus that can contain, store, communicate, propagate, or transport the program for use by or in connection with the instruction execution system, apparatus, or device.

A data processing system suitable for storing and/or executing program code may include at least one processor coupled directly or indirectly to memory elements through a system bus. The memory elements can include local memory employed during actual execution of the program code, bulk storage, and cache memories that provide temporary storage of at least some program code in order to reduce the number of times code must be retrieved from bulk storage during execution. Input or I/O devices (including but not limited to keyboards, displays, pointing devices, etc.) can be coupled to the system either directly or through intervening I/O controllers.

Network adapters may also be coupled to the system to enable the data processing system to become coupled to other data processing systems, storage devices, remote printers, etc., through intervening private and/or public networks. Wireless (e.g., Wi-Fi™) transceivers, Ethernet adapters, and Modems, are just a few examples of network adapters. The private and public networks may have any number of configurations and/or topologies. Data may be transmitted between these devices via the networks using a variety of different communication protocols including, for example, various Internet layer, transport layer, or application layer protocols. For example, data may be transmitted via the networks using transmission control protocol/Internet protocol (TCP/IP), user datagram protocol (UDP), transmission control protocol (TCP), hypertext transfer protocol (HTTP), secure hypertext transfer protocol (HTTPS), dynamic adaptive streaming over HTTP (DASH), real-time streaming protocol (RTSP), real-time transport protocol (RTP) and the real-time transport control protocol (RTCP), voice over Internet protocol (VOIP), file transfer protocol (FTP), WebSocket (WS), wireless access protocol (WAP), various messaging protocols (SMS, MMS, XMS, IMAP, SMTP, POP, WebDAV, etc.), or other known protocols.

Finally, the structure, algorithms, and/or interfaces presented herein are not inherently related to any particular computer or other apparatus. Various general-purpose systems may be used with programs in accordance with the teachings herein, or it may prove convenient to construct more specialized apparatus to perform the required method blocks. The required structure for a variety of these systems will appear from the description above. In addition, the specification is not described with reference to any particular programming language. It will be appreciated that a variety of programming languages may be used to implement the teachings of the specification as described herein.

The foregoing description has been presented for the purposes of illustration and description. It is not intended to be exhaustive or to limit the specification to the precise form disclosed. Many modifications and variations are possible in light of the above teaching. As will be understood by those familiar with the art, the specification may be embodied in other specific forms without departing from the spirit or essential characteristics thereof. Likewise, the particular naming and division of the modules, routines, features, attributes, methodologies, and other aspects are not mandatory or significant, and the mechanisms that implement the specification or its features may have different names, divisions and/or formats. Furthermore, the modules, routines, features, attributes, methodologies, and other aspects of the disclosure can be implemented as software, hardware, firmware, or any combination of the foregoing. Also, wherever a component, an example of which is a module, of the specification is implemented as software, the component can be implemented as a standalone program, as part of a larger program, as a plurality of separate programs, as a statically or dynamically linked library, as a kernel loadable module, as a device driver, and/or in every and any other way known now or in the future. Additionally, the disclosure is in no way limited to implementation in any specific programming language, or for any specific operating system or environment.

What is claimed is:

1. A computer-implemented method comprising:
identifying, by one or more processors, one or more editable elements on a graphical page displayed on a client device;
displaying, by the one or more processors, one or more graphical indications at the one or more editable elements on the graphical page;
receiving, by the one or more processors, a first user input selecting a first element of the one or more editable elements;
receiving, by the one or more processors, a second user input modifying the first element;
modifying, by the one or more processors, code of the graphical page based on the second user input to change an appearance of the graphical page; and
receiving, by the one or more processors, a third user input requesting an image capture of the changed appearance of the graphical page.

2. The computer-implemented method of claim 1, further comprising:
receiving, by the one or more processors, a fourth user input requesting to edit the appearance of the graphical page displayed on the client device, the fourth user input preceding the first user input.

3. The computer-implemented method of claim 2, wherein:
the graphical page includes a webpage displayed in a web browser; and
the code of the graphical page includes HTML.

4. The computer-implemented method of claim 1, further comprising:
responsive to receiving the third user input, removing, by the one or more processors, the one or more graphical indications of the one or more editable elements;
performing, by the one or more processors, a screen capture of the graphical page to generate an image file; and
storing, by the one or more processors, the generated image file in a database accessible to the one or more processors.

5. The computer-implemented method of claim 4, further comprising:
determining, by the one or more processors, one or more edges for the screen capture; and
performing, by the one or more processors, the screen capture using the one or more edges.

6. The computer-implemented method of claim 5, wherein:
wherein determining the one or more edges includes receiving a defined resolution for the screen capture.

7. The computer-implemented method of claim 1, wherein:
displaying the one or more graphical indications includes highlighting a plurality of content regions surrounding the one or more editable elements on the graphical page.

8. The computer-implemented method of claim 1, wherein:
displaying the one or more graphical indications includes highlighting the one or more editable elements on the graphical page when hovered over by a cursor on the graphical page.

9. The computer-implemented method of claim 1, wherein:
the first element includes text displayed on the graphical page;
receiving the second user input modifying the first element includes receiving text input at a location at which the first element is displayed on the graphical page; and
modifying the code of the graphical page based on the second user input includes replacing text corresponding to the text displayed on the graphical page with the received text in the code.

10. The computer-implemented method of claim 1, further comprising:
receiving, by the one or more processors, a fourth user input defining an HTML element; and
overlaying, the HTML element over the captured image.

11. A system comprising:
one or more processors; and
a memory storing instructions that, when executed by the one or more processors causes the system to perform operations comprising:
identifying one or more editable elements on a graphical page displayed on a client device;
displaying one or more graphical indications at the one or more editable elements on the graphical page;
receiving a first user input selecting a first element of the one or more editable elements;
receiving a second user input modifying the first element;
modifying code of the graphical page based on the second user input to change an appearance of the graphical page; and
receiving a third user input requesting an image capture of the changed appearance of the graphical page.

12. The system of claim 11, wherein the operations further comprise:
receiving a fourth user input requesting to edit the appearance of the graphical page displayed on the client device, the fourth user input preceding the first user input.

13. The system of claim 12, wherein:
the graphical page includes a webpage displayed in a web browser; and
the code of the graphical page includes HTML.

14. The system of claim 11, wherein the operations further comprise:
responsive to receiving the third user input, removing the one or more graphical indications of the one or more editable elements;
performing a screen capture of the graphical page to generate an image file; and
storing the generated image file in a database accessible to the one or more processors.

15. The system of claim 14, wherein the operations further comprise:
determining one or more edges for the screen capture; and
performing the screen capture using the one or more edges.

16. The system of claim 15, wherein:
wherein determining the one or more edges includes receiving a defined resolution for the screen capture.

17. The system of claim 11, wherein:
displaying the one or more graphical indications includes highlighting a plurality of content regions surrounding the one or more editable elements on the graphical page.

18. The system of claim 11, wherein:
displaying the one or more graphical indications includes highlighting the one or more editable elements on the graphical page when hovered over by a cursor on the graphical page.

19. The system of claim 11, wherein:
the first element includes text displayed on the graphical page;
receiving the second user input modifying the first element includes receiving text input at a location at which the first element is displayed on the graphical page; and
modifying the code of the graphical page based on the second user input includes replacing text corresponding to the text displayed on the graphical page with the received text in the code.

20. The system of claim 11, wherein the operations further comprise:
receiving a fourth user input defining an HTML element; and
overlaying, the HTML element over the captured image.
